(19) United States
(12) Patent Application Publication
(10) Pub. No.: US 2006/0133226 A1
(43) Pub. Date: Jun. 22, 2006

(54) Light source device

(75) Inventor: Jhy-Chain Lin, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/261,099

(22) Filed: Oct. 28, 2005

(30) Foreign Application Priority Data
Dec. 16, 2004 (CN) 200410077645.1

(51) Int. Cl. G11B 21/10; G11B 7/00

(52) U.S. Cl. 369/43

(57) ABSTRACT

A light source device includes a light source, a reflective filter and an optical absorber. The light source is used for emitting a light beam. The reflective filter is configured for selectively reflecting a first portion of the light beam emitted from the light source and for selectively transmitting a second portion thereof. The optical absorber is configured for absorbing the second portion of the light beam transmitted by said reflective filter. An optical system for an optical disk storage system is also provided. The optical system includes the light source device, an objective lens, and a detector. The objective lens is used for focusing the portion of the light beam onto an optical disk. The detector receives a return light beam reflected by the optical disk.

### BACKGROUND

1. Field of the Invention

The present invention is generally related to light source devices and, more particularly, to a light source device suitable for use in an optical disk storage system.

2. Related Art

An optical disk storage system provides means for recording and reproducing great quantities of data on and from an optical disk. The data is accessed by focusing a light beam onto a data layer of the optical disk and detecting a reflected light beam from the optical disk. Therefore, a light source should be provided in the optical disk storage system to emit the light beam. Usually, a semiconductor laser is employed in the optical disk storage system for providing a laser beam. A laser beam has been found to be advantageous for such an application as it has a good monochromaticity. However, the semiconductor laser is much more expensive than other kinds of light sources, such as a light emitting diode (LED). Hence, the light emitting diode has been introduced into the optical disk storage system instead of the semiconductor laser for reducing cost of the optical disk storage system.

Referring to FIG. 11, a conventional optical assembly 100 for an optical disk storage system is shown. The optical assembly 100 includes a light source unit 101, a collimating lens 110, an optical filter 120, a light path changing means 130, an objective lens 140, a condensing lens 150, and a photodetector 160. The light source unit 101 includes an LED 102 for emitting a light beam and a waveguide 103 for converging the light beam emitted from the LED 102. The converged light beam from the waveguide 103 is collimated by the collimating lens 110. Then, the collimated light beam is transmitted to the optical filter 120. The optical filter 120 has a bandwidth within 20 nm, so that the bandwidth of the light beam transmitted through the optical filter 120 is narrowed to within 20 nm. After the optical filter 120, a transmission direction of the collimated light beam is changed by the light path changing means 130, so as to illuminate the objective lens 140. The objective lens 140 focuses the incident light beam onto an optical disk 170 to form a focus spot 180 thereon. The optical disk 170 reflects the incident light beam, so as to form a reflected light beam. The reflected light beam sequentially passes through the objective lens 140 and the light path changing means 130 to illuminate the condensing lens 150. The condensing lens 150 condenses the reflected light beam onto the photodetector 160. Then, the photodetector 160 produces an output electrical signal based on the received reflected light beam.

In above-described optical module 100, the light beam incident on the optical disk 170 has a bandwidth within 20 nm. The monochromaticity of the light passing through the optical filter 120 is greatly improved relative to the light emitted from the LED 102. However, this improvement is also poor relative to the requirements of the optical disk storage system, especially in view of the rigorous requirements of a high-density optical disk storage system.

Therefore, a heretofore unaddressed need exists in the industry to address aforementioned deficiencies and inadequacies associated with the monochromaticity of light beams used in optical disk storage systems.

### SUMMARY OF THE INVENTION

A light source device includes a light source, a reflective filter and an optical absorber. The light source is used for emitting a light beam. The reflective filter is configured for selectively reflecting a first portion of the light beam emitted from the light source and for selectively transmitting a second portion thereof. The optical absorber is configured for absorbing the second portion of the light beam transmitted by the reflective filter.

One embodiment provides an optical system for an optical disk storage system. The optical system includes a light source device, an objective lens, and a detector. The light source device includes a light source, a reflective filter and an optical absorber. The light source is used for emitting a light beam. The reflective filter is configured for selectively reflecting a first portion of the light beam emitted from the light source and for selectively transmitting a second portion thereof. The optical absorber is configured for absorbing the second portion of the light beam transmitted by said reflective filter. The objective lens is used for focusing the portion of the light beam onto an optical disk. The detector is configured for receiving a return light beam reflected by the optical disk.

### BRIEF DESCRIPTION OF THE DRAWINGS

Many aspects of the present optical system can be better understood with reference to the following drawings. The components in the drawings are not necessarily to scale, the emphasis instead being placed upon clearly illustrating the principles of the present optical system. Moreover, in the drawings, like reference numerals designate corresponding parts throughout the several views.

FIG. 1 is a view of an arrangement of a light source device according to a first embodiment of the present optical system, also showing essential optical paths thereof;

FIG. 2 is a view of an arrangement of an optical system adopting the light source device of FIG. 1, also showing essential optical paths thereof;

FIG. 3 is a view of an arrangement of a light source device according to a second embodiment, also showing essential optical paths thereof;

FIG. 4 is a view showing reflection wavelengths of first, second and third optical fiber gratings when a light with a shortest wavelength is selected from a common light with three wavelengths;

FIG. 5 is a view showing reflection wavelengths of first, second and third optical fiber gratings when a light with a shorter wavelength is selected from a common light with three wavelengths;

FIG. 6 is a view showing reflection wavelengths of first, second and third optical fiber gratings when a light with a greatest wavelength is selected from a common light with three wavelengths;

FIG. 7 is a view of an arrangement of an optical system adopting the light source device of FIG. 3, also showing essential optical paths thereof;

FIG. 8 is a view showing the reflection performance of optical fiber gratings;

FIG. 9 is a view of an assembly of a first optical fiber grating and a first piezoelectric element of FIG. 3;

FIG. 10 is a view showing the relationship between a voltage applied to a piezoelectric element and a reflected wavelength of an optical fiber grating; and

FIG. 11 is a schematic, cross-sectional view of a conventional optical system for optical disk storage system, also showing essential optical paths thereof.

### DETAILED DESCRIPTION OF PREFERRED EMBODIMENTS

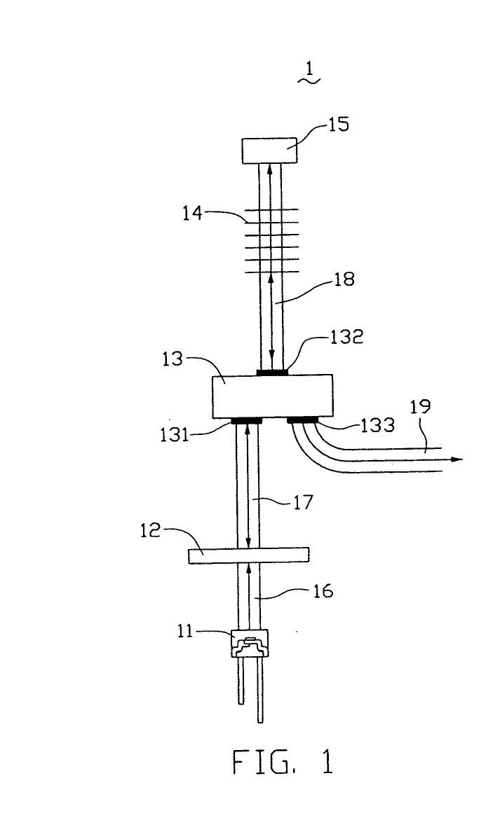

Referring to FIG. 1, a light source device 1 of a first embodiment is shown. The light source device 1 includes an LED 11, an isolator 12, a coupler 13, a reflective filter 14, an optical absorber 15, and several optical fibers 16, 17, 18 and 19. The LED 11 is a light source configured for emitting/generating a light beam. The isolator 12 is used for preventing the light beam from returning to the LED 11. A first optical fiber 16 interconnects the LED 11 and the isolator 12, guiding the light beam therebetween. After reaching the isolator 12, the light beam transmits to the coupler 13 via a second optical fiber 17.

The coupler 13 includes a first, second, and third port 131, 132, and 133, respectively, each connecting with a corresponding end of the second, a third and a forth optical fibers 17, 18 and 19. Thus, the light beam transmits into the coupler 13 from the first port 131. In the coupler 13, the light beam is diverted/redirected to the second port 132, so as to transmit to the reflective filter 14 via the third optical fiber 18.

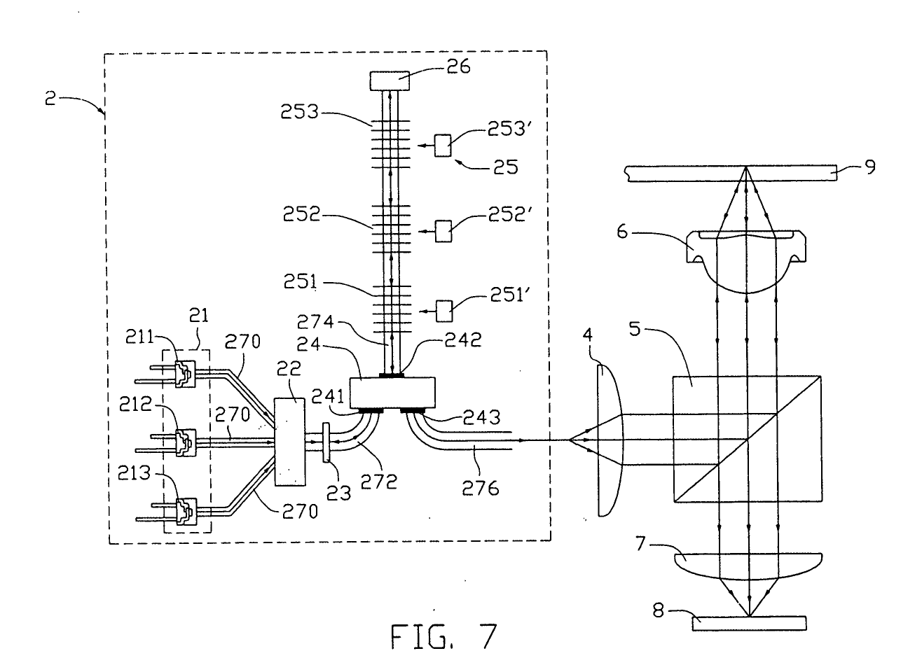

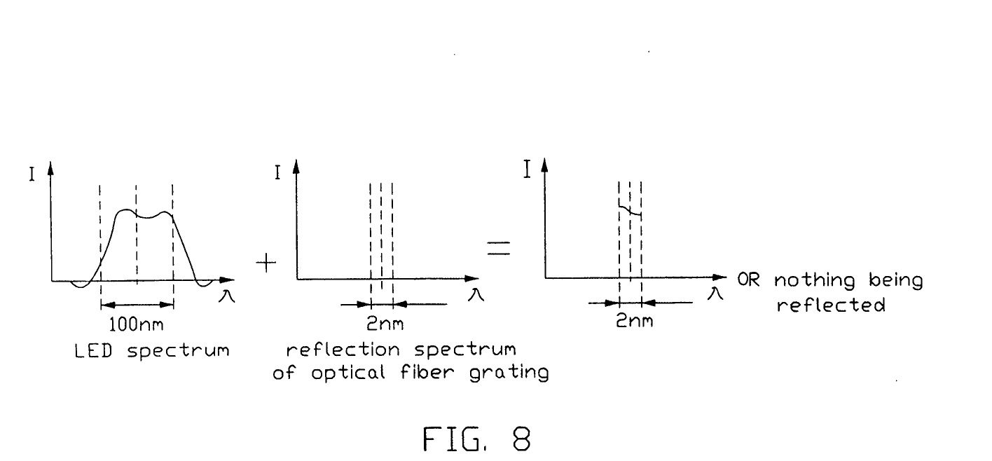

In this embodiment, the reflective filter 14 is an optical fiber grating 14 directly formed in the third optical fiber 18. The optical fiber grating 14 has a predetermined reflection wavelength and a predetermined bandwidth. That is, only a portion (i.e., a first portion) of the light beam, which has a wavelength within a range defined by the reflection wavelength and bandwidth of the optical fiber grating 14, can be reflected by the optical fiber grating 14 (shown in FIG. 8). For example, if the reflection wavelength of the optical fiber grating 14 is 650 nm and the bandwidth thereof is 2 nm, the light beam reflected by the optical fiber grating 14 should have a wavelength within 649-651 nm, while the portion (i.e., a second, remaining portion) of the light beam with any other wavelength would be transmitted through the optical fiber grating 14. Hence, even if the light beam emitted from the LED 11 has a wide bandwidth such as 100 nm, the bandwidth of the portion of the light beam reflected by the optical fiber grating 14 is narrowed to within a 2 nm-wavelength range.

A portion of the light beam, which is transmitted by the reflective filter 14, transmits to the optical absorber 15 via the third optical fiber 18. Another portion of the light beam, which is reflected from the optical fiber grating 14, is transmitted into the coupler 13 via the third optical fiber 18 and the second port 132. The coupler 13 redirects the light beam from the second port 132 to the third port 133. Then, the light beam transmits out of the light source device 1 via the fourth optical fiber 19.

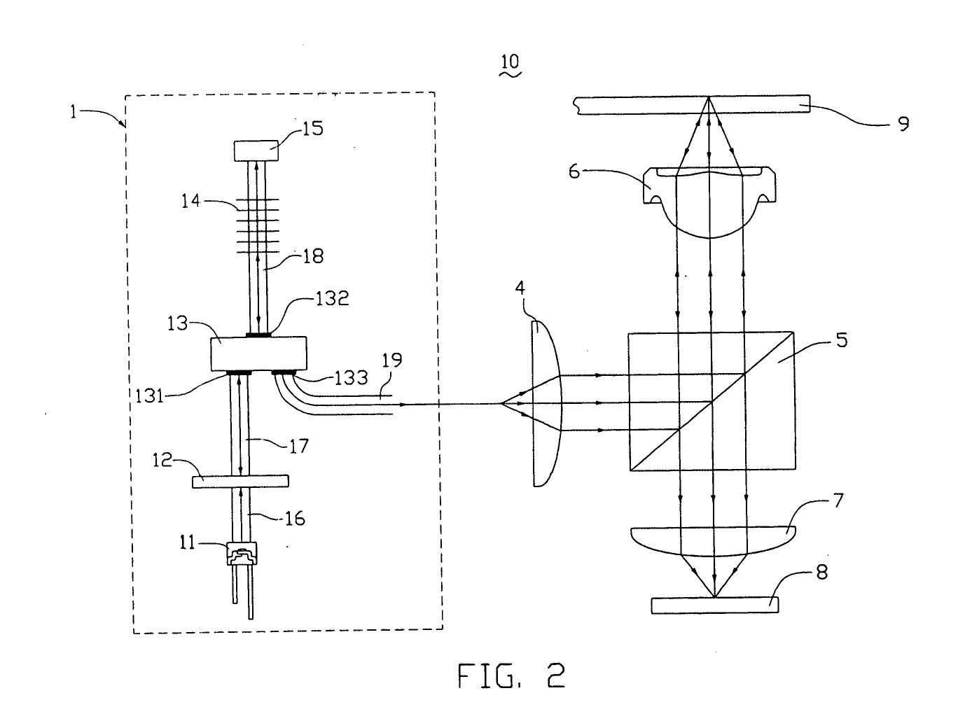

Referring to FIG. 2, an optical assembly 10 using the light source device 1 is shown. The optical assembly 10 is suitable (i.e., configured) for use in an optical disk storage system (not shown). The optical assembly 10 includes the above-mentioned light source device 1, a first collimator 4, a splitter 5, an objective lens 6, a second collimator 7, and a detector 8. The light beam with a narrow bandwidth is transmitted from the light source device 1 to the first collimator 4. The first collimator 4 converges the incident light beam into a parallel light beam. The parallel light beam transmits to the splitter 5. The splitter 5 reflects the incoming light beam, the reflected light beam thereby illuminating the objective lens 6. The objective lens 6 focuses the incident parallel light beam onto an optical disk 9, forming a focus spot thereon. The optical disk 9 reflects the incident focused light beam to form a reflected light beam. Then, the reflected light beam sequentially passes through the objective lens 6, the splitter 5, and the second collimator 7 to illuminate the detector 8. The detector 8 produces electrical output signals based on the received light beam. In the optical path from the light source device 1 to the detector 8, the bandwidth of the light beam is within 2 nm, approximating a bandwidth of a laser beam. Thereby, the light beam provided by the light source device 1 and used in the optical assembly 10 satisfies the monochromaticity requirement of the high-density optical disk storage system.

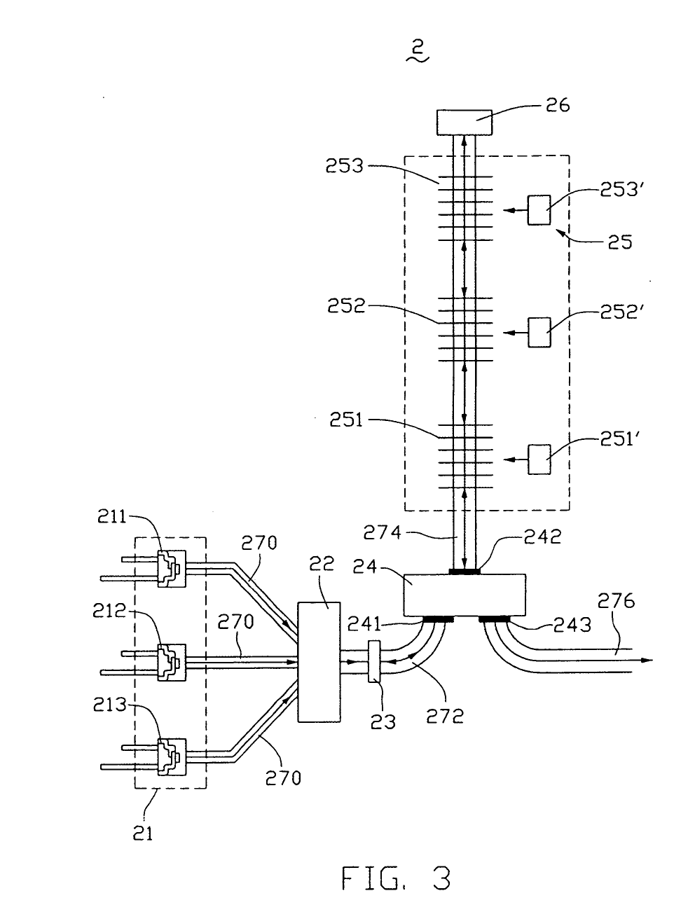

Referring to FIG. 3, a light source device 2 of a second embodiment is illustrated. The light source device 2 is adjustable for transmitting light beams with different wavelengths. The light source device 2 includes an LED array 21, a multiplexer 22, an isolator 23, a coupler 24, an adjustable reflective filter 25, an optical absorber 28, and several optical fibers 270, 272, 274, and 276. The LED array 21 is used for providing light beams with different wavelengths. The isolator 23 is configured for preventing the light beams from returning the LED array 21.

The LED array 21 includes a plurality of LEDs 211, 212 and 213 for emitting/generating lights, each with predetermined wavelengths within a respective wavelength range. Three LEDs 211, 212 and 213 are provided in this embodiment, but more or less LEDs also can be provided in alternative embodiments. In this embodiment, the LED 211 emits a first light beam with a first center wavelength such as 405 nm, the LED 212 emits a second light beam with a second wavelength greater than the first center wavelength, such as 650 nm, and the LED 213 emits a third light beam with a third center wavelength greater than the second center wavelength, such as 780 nm. Each one of the light beams has a bandwidth of about 100 nm.

Three first optical fibers 270 interconnect the three LEDs 211, 212, 213, respectively, with the multiplexer 22. Thus, the light beams emitted from the LEDs 211, 212 and 213 are synchronously transmitted to the multiplexer 22 via the first optical fibers 270. The multiplexer 22 couples the three light beams into a complex light beam with three wavelengths.

The coupler 25 has three polls 241, 242, and 243, e.g. a first port 241, a second port 242 and a third port 243, respectively, connecting with three corresponding optical fibers 272, 274, 276. A second optical fiber 272 is installed between the multiplexer 22 and the first port 241, allowing the complex light beam to transmit from the multiplexer 22 to the coupler 25. In the coupler 24, the complex light beam is diverted/redirected to the second port 274, which connects with a third optical fiber 274. Consequently, the complex light beam transmits to the adjustable reflective filter 25 via the third optical fiber 274.

The adjustable reflective filter 25 is configured for selectively reflecting a portion of an incident light beam based on a reflection wave band of the adjustable reflective filter 25. As a result, the adjustable reflective filter 25 reflects a portion of the complex light beam and transmits another portion thereof. The reflected portion of the complex light beam enters into the coupler 24 via the third optical fiber 274 and the second port 242, and transmits out from the third port 243 to a fourth optical fiber 276. On the other hand, the transmitted portion of the complex light beam transmits to the optical absorber 26 via the third optical fiber 274 to be absorbed thereby.

The adjustable reflective filter 25 includes a plurality of reflectors 251, 252, 253 (e.g. a first, second and third optical fiber gratings 251, 252, 253) and a plurality of controllers 251′, 252′, 253′ (e.g. a first, second, and third piezoelectric elements 251′, 252′ and 253′). The optical fiber gratings 251, 252, 253 are directly formed in the optical fiber 274 and have bandwidths of about 2 nm, respectively configured for selectively reflecting incident light beams (shown in FIG. 8).

The piezoelectric elements 251′, 252′ and 253′ are advantageously made of a PbZrO₃ material and are similar to each other. (It is, however, to be understood that each piezoelectric element 251′, 252′ and 253′ could be made of any of a variety of piezoelectric materials, with each being composed of the same or a different such material, and still be within the scope of the present optical system.) Now referring to FIG. 9, the first piezoelectric element 251′ includes a deformable portion 251′a and a connecting portion 251′b. The deformable portion 251′a is made of a piezoelectric (e.g., PbZrO₃) material. The connecting portion 251′b is U-shaped and has two opposite beams (not labeled) holding the deformable portion 251′a therebetween. The two beams have two ends connected with the third optical fiber 274 beside two opposite sides of the first optical fiber grating 251.

When a voltage is applied to the deformable portion 251′a, the deformable portion 251′a will deform so as to selectably compress or expand the first optical fiber grating 251. Thus, the grating spacing of the first optical fiber grating 251 will be changed following the compression or expansion. The change of the grating spacing will result in a change of the reflection wavelength of the first optical fiber grating 251. As shown in FIG. 10, the reflective wavelength of the first optical fiber grating 251 is proportional to the voltage applied to the piezoelectric element 251′.

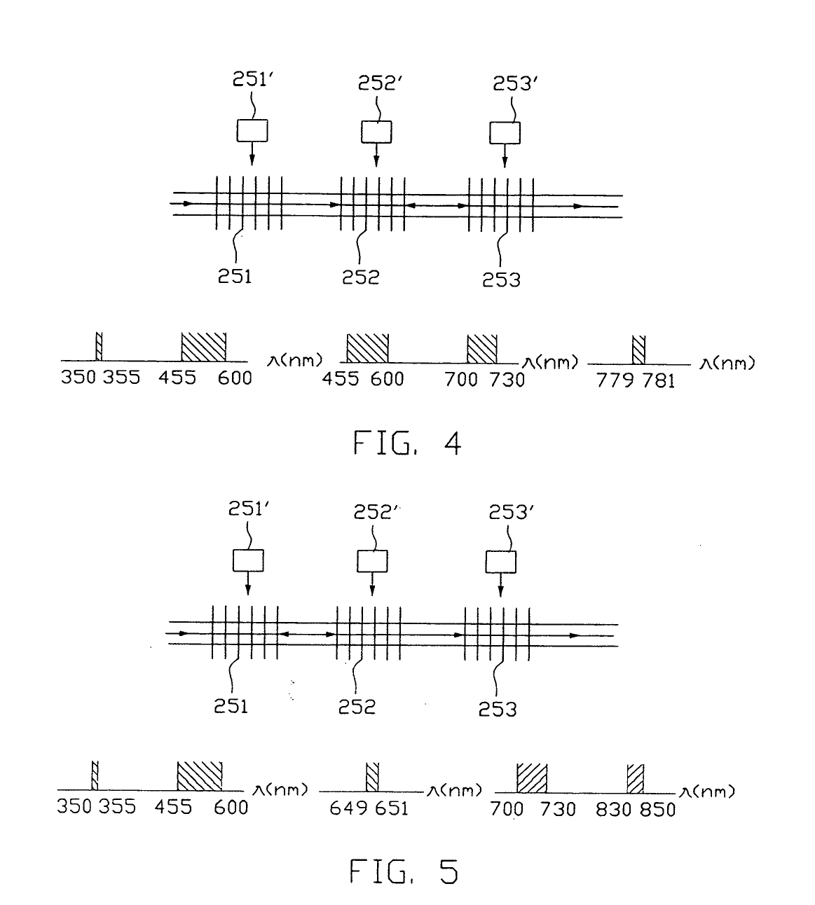

Referring to FIG. 4, a method of selecting the light beam with the first wavelength 405 nm from the complex light beam and narrowing the bandwidth thereof is shown. The reflection wavelength of the first optical fiber grating 251 is adjusted to be in a range of 405±1 nm when a first predetermined voltage is applied on the first piezoelectric element 251′. The reflection wavelength of the second optical fiber grating 252 is adjusted to be in a range of 455-600 nm or 700-730 nm when a second predetermined voltage is applied to the second piezoelectric element 252′. The reflection wavelength of the third optical fiber grating 253 is adjusted to be in a range of 700-730 nm or 830-850 nm when a third predetermined voltage is applied to the third piezoelectric element 253′.

When the complex light beam transmits into the first optical fiber grating 251, the first optical fiber grating 251 reflects a portion of the complex light beam, specifically the portion thereof having a wavelength within 405±1 nm, and transmits any other portion of the complex light beam. The reflected portion is directed to the fourth optical fiber 276 via the third optical fiber 274 and the coupler 24. The portion transmitted beyond the first optical fiber grating 251 reaches the second optical fiber grating 252, via the third optical fiber 274. The light beam transmitted from the first optical fiber grating 251 has no wavelength in the range of the reflection wavelength of the second optical fiber grating 252 and is thereby transmitted in its entirety by the second optical fiber grating 252. The light beam transmitted from the second optical fiber grating 252 also has no wavelength in the range of the reflection wavelength of the third optical fiber grating 253, and, as such, is entirely transmitted by the third optical fiber grating 253. The light beam transmitted by the third optical fiber grating 253 is absorbed by the optical absorber 26. The reflection wavelength of the second optical fiber grating 252 is adjusted to be in a range of 455-600 nm or 700-730 nm, when a second predetermined voltage is applied on the second piezoelectric element 252′. The reflection wavelength of the third optical fiber grating 253 is adjusted to be in a range of 700-730 nm or 830-850 nm, when a third predetermined voltage is applied on the third piezoelectric element 253′.

Referring to FIG. 5, a method to select the light beam with the second wavelength 650 nm from the complex light beam and to further narrow the bandwidth thereof is shown. The reflection wavelength of the first optical fiber grating 251 is adjusted to be in a range of 300-355 nm or 455-600 nm, when a fourth predetermined voltage is applied to the first piezoelectric element 251′. The reflection wavelength of the second optical fiber grating 252 is adjusted to be in a range of 650±1 nm, when a fifth predetermined voltage is applied to the second piezoelectric element 252′. The reflection wavelength of the third optical fiber grating 253 is adjusted to be in the range of 700-730 nm or 830-850 nm, when the third predetermined voltage is applied to the third piezoelectric element 253′.

When the complex light beam transmits into the first optical fiber grating 251, the first optical fiber grating 251 transmits the whole light beam to the second optical fiber grating 252. The second optical fiber grating 252 reflects a portion of the complex light beam, which has a wavelength within 650±1 nm, and transmits any other portion of the complex light beam. The reflected portion transmits to the first optical fiber grating 252 and, again, is transmitted by the first optical fiber grating 252. Then, the reflected portion transmits out of the light source device 2 after subsequently passing through the third optical fiber 274, the coupler 24, and the forth optical fiber 276. However, the portion transmitted through the second optical fiber 252 transmits to the third optical fiber grating 252, as well. The third optical fiber grating 252 transmits the whole light beam incident thereupon to the optical absorber 26 because of the unmatched wavelength. The optical absorber 26 absorbs the incident light beam, as transmitted by the third optical fiber grating 252.

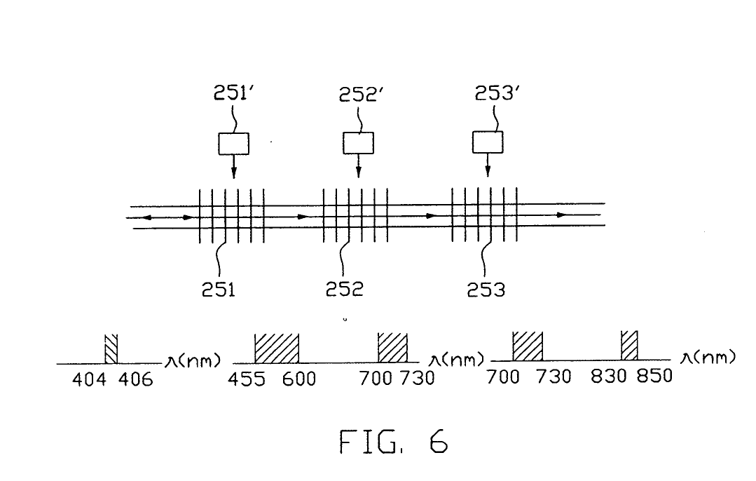

Referring to FIG. 6, a method to select the light beam with the third wavelength 780 nm from the complex light beam and to narrow the bandwidth thereof is shown. The reflection wavelength of the first optical fiber grating 251 is adjusted to be in the range of 300-355 nm or 455-600 nm, when the fourth predetermined voltage is applied to the first piezoelectric element 251′. The reflection wavelength of the second optical fiber grating 252 is adjusted to be in the range of 455-600 nm or 700-730 nm when the second predetermined voltage is applied to the second piezoelectric element 252′. The reflection wavelength of the third optical fiber grating 253 is adjusted to be in a range of 780±1 nm when a sixth predetermined voltage is applied to the third piezoelectric element 253′.

When the complex light beam transmits to the adjustable reflective filter 25, the first and second optical fiber gratings 251, 252 subsequently transmit the whole incident complex light beam because of unmatchable wavelengths therebetween. Accordingly, then, the complex light beam transmits to the third optical fiber grating 253, and the third optical fiber grating 253 reflects a portion of the complex light beam having a wavelength within 780±1 nm and transmits any other portion of the complex light beam. The reflected portion of the complex light beam is subsequently transmitted by the first and second optical fiber gratings 251, 252. Then, the reflected portion of the complex light beam transmits out of the light source device 2 after passing through the coupler 24 and the fourth optical fiber 276. The transmitted portion of the complex light beam, passing through the third optical fiber grating 253, reaches the optical absorber 26 to be absorbed.

Now, referring to FIG. 7, an optical assembly 20 for optical disk storage system capable of reading different type disks is shown. The structure of the optical system is similar to the above-described optical system 10, but the optical system 20 employs the light source device 2 of the second embodiment instead of the light source device 1 of the first embodiment.

It should be emphasized that the above-described embodiment of the present invention is merely possible example of implementation, merely set forth for a clear understanding of the principles of the invention. Many variation and modifications may be made to the above-described embodiment of the invention without departing substantially from the spirit and principles of the invention. All such modifications and variations are intended to be included herein and to be considered to be within the scope of this disclosure and the present invention and protected by the following claims.

What is claimed is:

1. A light source device comprising:
a light source configured for emitting a light beam;
a reflective filter configured for selectively reflecting a first portion of the light beam emitted from said light source and for selectively transmitting a second portion thereof; and
an optical absorber configured for absorbing the second portion of the light beam transmitted by said reflective filter.

2. The light source device in accordance with claim 1, wherein said light source includes a light emitting diode configured for emitting the light beam, the light beam having a first bandwidth.

3. The light source device in accordance with claim 2, wherein said reflective filter has a predetermined second bandwidth associated therewith, the second bandwidth being narrower than the first bandwidth of the light beam.

4. The light source device in accordance with claim 3, wherein said second bandwidth is 2 nm.

5. The light source device in accordance with claim 1, wherein said reflective filter is an optical fiber grating.

6. The light source device in accordance with claim 1, further comprising a coupler located in an optical path between said light source and said reflective filter, said coupler being configured for transmitting the light beam from said light source to said reflective filter and outputting the first portion of the light beam.

7. The light source device in accordance with claim 1, further comprising an optical fiber configured for transmitting the light beam from said light source to said reflective filter.

8. The light source device in accordance with claim 7, wherein said reflective filter is an optical fiber grating formed in said optical fiber.

9. The light source device in accordance with claim 1, wherein said light source includes at least two light emitting diodes configured for emitting light beams within different respective wavelength ranges.

10. The light source device in accordance with claim 9, wherein said reflective filter is adjustable to selectively reflect a portion of one of the light beams.

11. The light source device in accordance with claim 10, wherein said reflective filter includes at least two optical fiber gratings corresponding to the light emitting diodes and at least two controllers configured for adjusting the optical fiber gratings.

12. The light source device in accordance with claim 11, wherein the controllers are piezoelectric elements.

13. The light source device in accordance with claim 12, wherein each controller includes a deformable portion and a connecting portion, said deformable portion being made of a piezoelectric material, said connecting portion holding said deformable portion and connecting with each optical fiber, said connecting portion being configured for selectably compressing and expanding a section of the optical fiber, the section of the optical fiber having an optical grating formed therein.

14. The light source device in accordance with claim 9, further comprising a multiplexer located in an optical path between said light source and said reflective filter, said coupler being configured for composing the light beams generated by said at least two light emitting diodes to form a complex light beam.

15. An optical system for an optical disk storage system, said optical system comprising:
a light source device comprising:
a light source configured for emitting a light beam;
a reflective filter configured for selectively reflecting a first portion of the light beam emitted from said light source and for selectively transmitting a second portion thereof; and
an optical absorber configured for absorbing the second portion of the light beam transmitted by said reflective filter;
an objective lens configured for focusing the first portion of the light beam onto an optical disk; and
a detector configured for receiving a return light beam reflected by the optical disk.

16. The optical system in accordance with claim 15, wherein said light source includes a light emitting diode configured for emitting the light beam, the light beam having a first bandwidth, said reflective filter being an optical fiber grating with a second bandwidth, said second bandwidth being smaller than said first bandwidth.

17. The optical system in accordance with claim 15, wherein said light source includes at least two light emitting diodes configured for emitting light beams within different respective wavelength ranges, said reflective filter being adjustable to reflect a portion of one of the at least two light beams.

18. The optical system in accordance with claim 17, wherein said reflective filter includes at least two optical fiber gratings corresponding to the light emitting diodes and at least two piezoelectric elements configured for adjusting said optical fiber gratings.
